(19) United States
(12) Patent Application Publication
(10) Pub. No.: US 2011/0210596 A1
(43) Pub. Date: Sep. 1, 2011

(54) ONE-PIECE SEAT STRUCTURE AND COLD FORMING PROCESSES TO CREATE SEAT STRUCTURES

(75) Inventors: Ornela Zekavica, Novi, MI (US); Daniel James Sakkinen, Highland, MI (US); Antoine Kmeid, Canton, MI (US); Youzhi Xiong, Northville, MI (US); John David Kotre, Ann Arbor, MI (US); Catherine M. Amodeo, Livonia, MI (US)

(73) Assignee: Johnson Cintrols Technology Company

(21) Appl. No.: 13/122,591

(22) PCT Filed: Oct. 16, 2009
(86) PCT No.: PCT/US09/61027

§ 371 Date: May 10, 2011

Related U.S. Application Data
(60) Provisional application No. 61/228,836, filed on Jul. 27, 2009.
(60) Provisional application No. 61/106,045, filed on Oct. 16, 2008.

(51) Int. Cl. B60N 2/68; B60N 2/44; B23P 11/00

(52) U.S. Cl. 297/452.18; 297/452.1; 29/428

(57) ABSTRACT

A one-piece seat structure for use in a vehicle seat assembly comprising a first portion having a first set of characteristics; a second portion having a second set of characteristics; wherein the first set of characteristics differs from the second set of characteristics and wherein the number of portions within the same one piece structure can be multiple; and wherein the one-piece seat structure is formed from a tailored welded blank or monolithic blank using a cold forming process with optional additional post forming processes including post form heat treatment, edge treatment, and the like.

### CROSS-REFERENCE TO RELATED APPLICATIONS

This application claims the benefit of and priority to U.S. Provisional Patent Application No. 61/106,045, filed Oct. 16, 2008, titled: ONE-PIECE SEAT STRUCTURES AND PROCESSES USING COLD FORMING TO CREATE SEAT STRUCTURES, in the name of Zekavica et al. and U.S. Provisional Patent Application No. 61/228,836, filed Jul. 27, 2009, titled: ONE-PIECE SEAT STRUCTURES AND METHOD OF FORMING, in the name of Zekavica et al., which are incorporated by reference herein.

### BACKGROUND

The present disclosure relates generally to the field of seating for vehicles. More specifically, this disclosure relates to one-piece seat structures and processes using cold forming to create seat structures.

Seat structures (e.g., seat back frames, seat base cushion frames, low seat structures, back frame seat belt towers, etc.) can provide strength to a seat assembly to meet strength and/or durability requirements that are commonly covered by governmental regulations (e.g., FMVSS, ECE) or suggested and/or dictated by other groups (e.g., by vehicle manufacturers, insurance groups, etc.). Seat structures also can be configured to meet the desires of customers (and hence vehicle manufacturers) for seat assemblies that provide increased functionality or utility (e.g., rotating, folding, sliding, etc.) while improving user-adjustable comfort. Achieving the desired material, structural, functional, and utility characteristics (e.g., strength, stiffness, thickness, microstructure, stress, strain, durability, etc.) typically requires the use of additional components, which can have an undesirable impact on mass, cost, and comfort. Seat structures are typically designed by balancing structural and functional characteristics against mass, comfort, and cost.

Generally, it is known to construct a seat structure by separately forming individual members using a conventional stamping process (e.g., a multiple station progressive stamping die), and then coupling those formed members, e.g., using a welding (e.g., laser, GMAW) process or the like to couple the formed members. This method of construction has several disadvantages, at least some of which are as follows. First, the welding process for joining formed components, especially laser welding, requires tight tolerances with respect to parameters (e.g., gap) to produce a reliable structural weld, which can require complex and expensive fixtures or tooling during the manufacturing cycle. Second, concerns about reduced reliability resulting from the tight tolerances may cause manufacturers to couple the members with redundant welds to increase reliability, which adds to piece cost and cycle time of manufacture. Third, individual stamping dies or tooling may be required to produce each individual member, which adds to piece cost and maintenance cost. Fourth, a higher number of individual members used to construct a seat structure results in a higher likelihood that the lack of one member will stop the entire production process of a seat structure. Fifth, this method of construction requires significant part handling downstream in the manufacture process, which adds to the piece cost. Sixth, this method of construction can inhibit optimization of mass and strength, as the desire to reduce costs by having as few parts as possible in the assembly can cause manufacturers to structurally overdesign portions of the seat structure to achieve part reduction. Seventh, some conventional methods of coupling (e.g., GMAW, fasteners) require overlaps and/or the addition of material, such as extra parts or filler material, which negatively impacts mass and cost. Eighth, the coupling of multiple individual stamped members typically requires a significant number of welds, for example, a conventional four member back frame structure may require more than twenty welds to couple the members into one assembly. The need for this high quantity of welds in combination with conventional weld fixtures (e.g., a rotating carousel fixture) result in slow manufacturing cycle times.

There is a need to design and form structural components with reduced mass and reduced cost, while meeting or exceeding increased strength and durability requirements. Additionally, because the structural components of a seat assembly of a vehicle provide safety related functionality, there is always a need to increase reliability of the processes and components that are in the load path during a dynamic vehicle impact event. There also is a need for additional functionality with a minimal impact on comfort, mass, and cost. Additionally, the cost to handle or modify the component increases significantly as a product moves downstream in its manufacturing cycle, hence there is a desire to reduce or eliminate downstream operations.

### SUMMARY

A one-piece seat structure for use in a vehicle seat assembly, the one-piece seat structure comprising: a first portion having a first set of material, structural, functional, and utility characteristics (e.g., strength, stiffness, thickness, microstructure, stress, strain, durability, etc.); a second portion having a second set of material, structural, functional, and utility characteristics (e.g., strength, stiffness, thickness, microstructure, stress, strain, durability, etc.); wherein the first set of material characteristics differs from the second set of material characteristics; and wherein the one-piece seat structure is formed from a tailor welded blank using a cold-forming process, the tailor welded blank constructed from the first portion coupled to the second portion. The number of different portions with different characteristics can vary and will go from two to multiple portions. Also, the one-piece seat structure may be formed from a monolithic blank (uniform material property and thickness) using a cold-forming process. The needed structural performances are achieved via specific topography (stiffeners geometry) obtained within the forming of the one-piece structure. Also, the one-piece seat structure can be formed from a blank partially or entirely made (or formed) from a heat treatable material. In this embodiment, the one-piece structure will be first formed using a cold-forming process and then needed structural performances will be obtained by applying some of the post cold-forming heat treatment processes to the seat structure.

In one exemplary embodiment, a vehicle seat assembly includes a seat back rotatably coupled to a seat base; wherein at least one of the seat base and seat back comprises a one-piece structure comprised of: a first portion having a first set of characteristics and a second portion having a second set of characteristics, wherein the first set of characteristics differs from the second set of characteristics; and wherein the one-piece seat structure is formed from a tailor welded blank and a monolithic blank using a cold-forming process, the tailor welded blank constructed from the first portion coupled to the second portion.

A method of forming a one-piece seat structure, the method comprising the steps of: constructing a tailor welded blank by coupling a first portion having a first set of characteristics to a second portion having a second set of characteristics, wherein the first set of characteristics differs from the second set of characteristics or a monolithic blank; and forming the one-piece seat structure from a tailor welded blank or monolithic blank using a cold-forming process.

### BRIEF DESCRIPTION OF THE DRAWINGS

FIG. 1 is a perspective view of an exemplary embodiment of a motor vehicle.

FIG. 2 is a perspective view of an exemplary embodiment of a seat assembly for use within a motor vehicle, such as the motor vehicle of FIG. 1.

FIG. 3 is a flow diagram illustrating examples of manufacturing processes for producing an exemplary seat structure.

FIG. 4A is a front view of a tailored welded blank for forming a seat structure (such as a one-piece seat back structure) for use with a seat assembly, according to an exemplary embodiment.

FIG. 4B is a perspective view of a one-piece seat back structure, according to an exemplary embodiment.

FIG. 4C shows cross-sections of the one-piece seat back structure of FIG. 4B, taken along the areas corresponding to lines A-A and B-B in FIGS. 4A and 4B.

FIG. 5 is a front view of another tailored welded blank for forming a seat structure (such as a one-piece seat back structure) for use with a seat assembly, according to an exemplary embodiment.

FIG. 6 is a perspective view of a one-piece seat back structure, according to an exemplary embodiment.

FIG. 7 is a perspective view of a conventional seat back structure constructed from multiple individually formed components.

FIG. 8A is a front view of portions of another tailored welded blank for forming a seat structure (such as a one-piece seat back structure), prior to joining the portions, for use with a seat assembly, according to an exemplary embodiment and prior to cold forming.

FIG. 8B is a front view of the tailored welded blank of FIG. 8A, after joining the portions through a joining process, such as laser welding.

FIG. 8C is a front view of the tailored welded blank of FIG. 8B, including a pre-form in the side member portions.

FIG. 8D is a front view of the tailored welded blank of FIG. 8C, illustrating the location of the bending lines from the forming process.

FIG. 8E is a perspective view of the tailored welded blank of FIG. 8A-8C, post forming, illustrating the improved sectional properties local to typically high stress regions.

FIG. 8F is a front view of a monolithic blank for forming a seat structure (such as a one-piece seat back structure), for use with a seat assembly, according to an exemplary embodiment prior to forming.

FIG. 9 is a perspective view of a seat base/cushion structure, according to an exemplary embodiment.

FIG. 10 is a perspective view of seat base bracket assemblies, according to an exemplary embodiment.

FIG. 11 is a perspective view of a seat base cushion pan, according to an exemplary embodiment.

FIG. 12 is a perspective view of another embodiment of a seat base cushion pan.

FIG. 13 is a perspective view of a riser structure, according to an exemplary embodiment.

FIG. 14 is a perspective view of a two occupant seat back structure, according to an exemplary embodiment.

FIG. 15 is a perspective view of a pivotable two occupant seat cushion structure, according to an exemplary embodiment.

### DETAILED DESCRIPTION

Referring generally to the FIGURES, there are disclosed one-piece seat structures 5 for use within a seat assembly 12 for use in a motor vehicle 10 and processes for forming the seat structures 5. Based on the present disclosure, a one-piece seat structure 5 can be configured to achieve, for example, desired strength, durability, functionality, utility, mass, cost, and/or user comfort characteristics.

A tailored welded blank 16 formed in accordance with the present invention offers the ability to, for example, integrate components, minimize scrap, reduce handling, reduce cost and optimize strength and mass. For example, mass and cost can be optimized by flexibly optimizing the material (i.e., mechanical properties) and thickness at differing sections of a tailored welded blank 16 to meet requirements of strength and manufacturing. The tailored welded blank 16 can then be formed through a cold-forming process to produce a one-piece structural component 5, which may have complex geometry yet require fewer secondary operations and less expensive fixtures or tooling. The one-piece seat structure 5 can be optimized for cost and mass, which meets or exceeds strength and durability requirements and the strength and durability of conventional seat structures. Also, this optimization of mass can allow for construction of a smaller seat 12, which in turn can provide increased space within the vehicle 10 for cargo or comfort. The mass reduction of seat components can have a ripple effect for vehicle manufacturers, as mass reduction affects the design of other components (e.g., brakes, powertrain) and can allow for other components that are lower mass, smaller, more efficient, etc., which can lead to other cost savings in the vehicle 10.

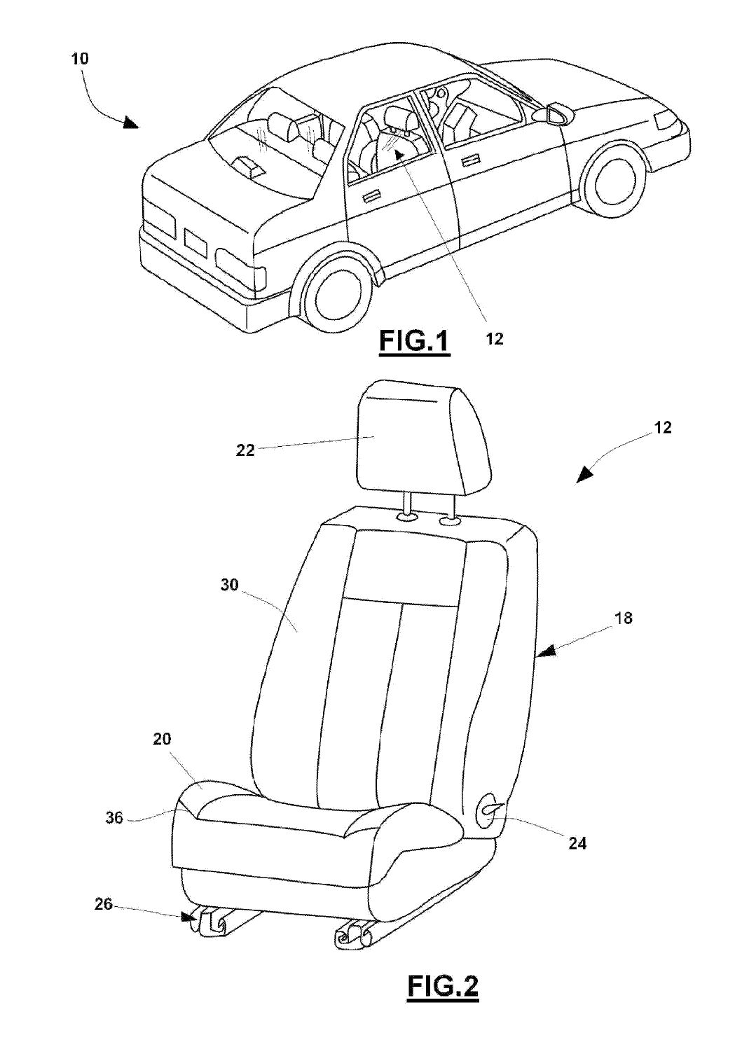

Referring to FIG. 1, a vehicle 10 is shown according to an exemplary embodiment. The vehicle 10 can include one or more seat assemblies 12 provided for occupant(s) of the vehicle 10. FIG. 2 shows an exemplary embodiment of such a seat assembly 12. While the vehicle 10 shown is a four door sedan, it should be understood that the seat assembly 12 may be used in a mini-van, sport utility vehicle, airplane, boat, or any other vehicle.

As shown in FIG. 2, the seat assembly 12 can include a seat back 18, to provide comfort to the occupant and strength during a dynamic impact event; a seat cushion (base) 20, to provide comfort to the occupant and strength during a dynamic impact event; a head rest 22, to help prevent whiplash of the occupant during a dynamic impact event; a recliner mechanism 24, to provide rotatable adjustability of the seat back 18 with respect to the seat cushion 20; and a track assembly 26, to provide adjustability for comfort or utility. The seat back 18 can include, for example, a foam pad 28, a trim cover 30, and a one-piece seat back structure 32. The seat cushion 20 can include, for example, a foam pad 34, a trim cover 36, and a one-piece seat cushion structure 38. The seat assembly 12 illustrated is a one-occupant seat typically used in the front row of a vehicle, but a one-piece structure 5 may be incorporated into any seat assembly (e.g., second row bench, third row fold flat), which may utilize any type of seat functionality, for use within any vehicle.

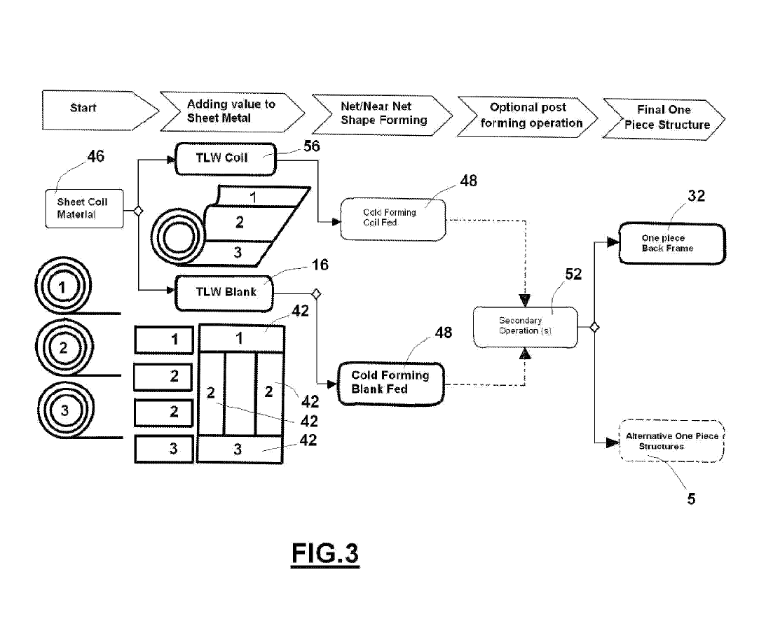

FIG. 3 is a flow diagram illustrating process concepts that may be used to construct an exemplary seat structure, such as a one-piece seat structure 5. In overview, a blank 40 (e.g., a tailored welded blank 16) can be constructed by, for example, using conventional means (e.g., laser welding) to couple two or more portions 42 (e.g., steel portions) into (1) a shape that directly creates the blank 40 or (2) a length of material 44 that can be rolled into a coil of material 46 that is processed to form the blank 40. The blank 40 can then be formed by a forming process 48 (preferably a cold-forming process 50) to produce the one-piece seat structure 5 (e.g., one-piece seat back frame 32, etc.). Optionally, post-forming operations 52 can be performed after the initial forming process 48 to provide additional features that enhance function or performance, and to provide improved properties, characteristics, configurations, etc. (e.g., partial heat treatment for added strength, etc.).

The tailored welded blank 16 can be constructed by coupling the portions 42 directly into the shape of the blank 16 by using any of various suitable techniques. For example, the portions 42 can be obtained by cutting sections 54 of desired size and shape from one coil of sheet material 46 or from multiple coils of sheet material 46 (e.g., wherein the properties of the sheet material are uniform on each given coil, but differ from one coil to the next). The portions cut 54 from the coil(s) 46 then can be positioned in a desired configuration and coupled together to form the tailored welded blank 16, which will then be shaped using the cold-forming process 50. Tailored welded blanks 16 can be configured in a variety of ways by, for example, varying the shape, size, quantity, material, and thickness of the portions 54, as well as varying the relative positions of different portions prior to coupling.

Alternatively, the portions cut from the coil(s) 54 (e.g., portions made from different materials with different material thicknesses) can be coupled together (e.g., laser welded) and then rolled again into a single coil of steel to form a tailored welded coil 56 having material of different properties along its width. The tailored welded coil 56 can then be partially unrolled, a section 58 cut therefrom, and the section 58 can be trimmed by any appropriate (including conventional) means to form an entire tailored welded blank 16. As another alternative, sections 58 can be cut from the tailored welded coil 56 (and possibly other coils), and those sections 58 can then be positioned in a desired configuration and coupled together to form the tailored welded blank 16, which will then be shaped using the cold-forming process 50. Another alternative would be to continuously feed a tailored welded coil 56 directly into a die 60 (e.g., progressive, transfer) to form a tailored component 62. Blanks 16 formed from tailored welded coils 56 can be configured in a variety of ways by, for example, varying the coil 56 strip widths, varying the shape, size, quantity, material, and/or thickness of the portions 42, as well as varying the relative position of different portions 42 prior to coupling.

The portions 42 that are coupled to form the tailored welded blank 16 (or to form the tailored welded coil 56 that ultimately becomes the tailored welded blank 16) can have different characteristics. For example, the portions 42 may be made from different materials and/or they may have different thicknesses. Tailored welded blanks 16 are flexible in regard to varying the properties (e.g., blank size, shape, mechanical properties, thickness, etc.) of the different portions 42 to be coupled, which optimizes the mass and structural characteristics of the one-piece structure 5 by allowing each portion 42 to be designed to meet a specific strength. Tailored welded blanks 16 reduce part cost by minimizing scrap through more efficient nesting of the portions 42, and tooling cost by requiring simpler and/or less tooling, than conventional seat structures, to achieve reliable welds. The tooling of tailored welded blanks 16 may be simpler and less expensive, because the blanks 16 being coupled are not formed prior to coupling, thus have more dimensionally stable coupling features which allows for less complex (less expensive) fixtures to achieve the necessary joining (e.g., weld, etc.) parameters (e.g., gap, etc.) to produce a reliable weld. This increase in weld reliability also allows for the reduction of redundant welds, which further reduces cost and cycle time. The more mass-optimized tailored welded blank 16 may be cold formed (i.e., pressed between tooling at conventional ambient temperature) to form a mass and cost optimized one-piece seat structure 5. The one-piece seat structure 5 requires fewer (than conventional structures) if any secondary operations, as the tooling may produce complex geometry, which significantly reduces the handling as compared to conventional structures.

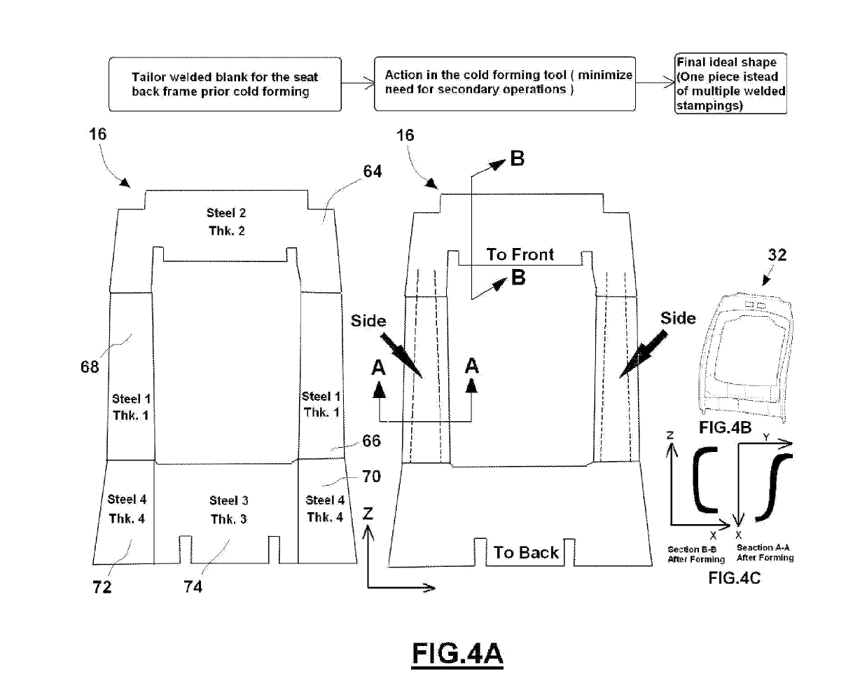

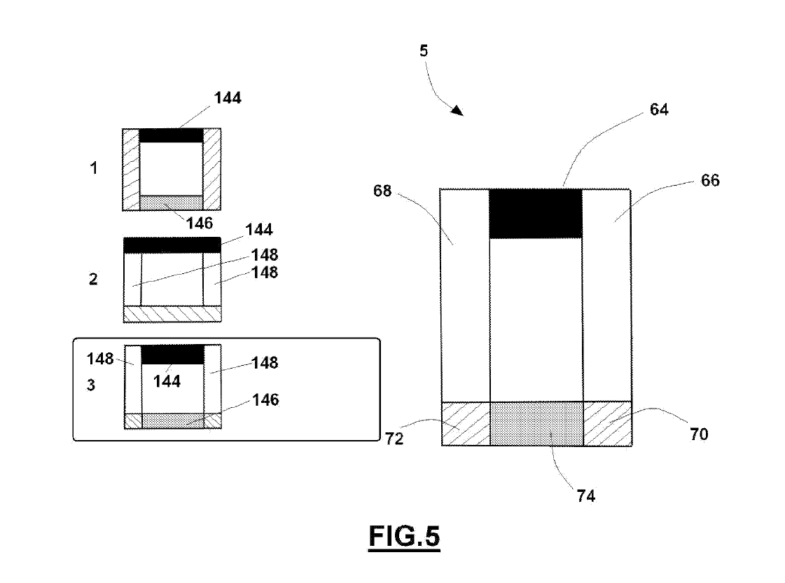

Referring to FIGS. 4A thru 5, exemplary embodiments of tailored welded blanks 16 for use in constructing a one-piece seat back structure 32 are shown. According to the exemplary embodiments, the tailored welded blanks 16 each include six portions (P1-P6) 64, 66, 68, 70, 72, 74, though the number of portions can be more or less depending on a variety of factors, such as cost to weld, material costs, performance requirements, etc. Portion one (P1) 64 can be made, for example, from medium grade (420 MPa yield strength) high strength low-alloy (HSLA) steel that is 0.8 min thick. Portions two and three (P2 and P3) 66, 68 can be made, for example, from medium grade HSLA steel that is 0.955 mm thick. Portions four and five (P4 and P5) 70, 72 can be made, for example, from high grade (550-1000 MPa yield strength) HSLA steel that is 1.0 mm thick. Portion six (P6) 74 can be made, for example, from low grade (340 MPa yield strength) HSLA steel that is 0.9 mm thick. These materials and thicknesses are merely shown as examples, and they can be modified as appropriate. FIG. 5 shows three exemplary options for constructing a one-piece seat structure 5 (e.g., one-piece seat back frame 32, etc.) from two or more different types of material (e.g., steel one 144, steel two 146, and steel three 148, etc.). For example, according to option three, the one-piece seat structure 5 may be constructed from six portions having different material properties. Portion one 64 (HSLA option: SAE J2340, Grade 420 XF; DP Option: DP 780/800, t=0.7 mm), portion two 66 and three 68 (HSLA Option: SAE J2340, Grade 420 XF; DP Option: DP 780/800, mm), portion four 70 and five 72 (Alternate Option: 22MnB5, 1.0 mm THK; HSLA Option: SAE J2340, Grade 420×F, t=1.2 mm; DP Option: DP 780/800, t=1.1 mm), and portion six 74 (SAE J2340, Grade 420 XF, t=0.9 mm). Using option three provides the most material placement flexibility which provides more opportunity for mass reduction. The same individual material, as an example, can be implemented in the case of the one piece structure from a monolithic blank having different thickness. The monolithic blank can be made from different advanced steels such as TRIP or TWIP steels.

The multiple portions (P1 through P6) 64, 66, 68, 70, 72, 74 are coupled through a conventional process (e.g.; laser welding, etc.) into a tailored welded blank 16 prior to forming. The simple geometry of each portion improves weld reliability, by having more dimensionally stable weld features (e.g., gap, etc.), and decreases tooling cost, by allowing for less complex tooling which would be required to compensate for a less dimensionally stable part. The conventional method of coupling components post forming drives this dimensional instability and requires more expensive fixtures to assure reliable welds. The increased weld reliability of tailored welded blanks 16 allows for the elimination of redundant welds, which are required on conventional structures due to the less reliable welds. An exemplary tailored welded blank 16 comprising of six portions may be coupled with six welds, while another embodiment of a tailored welded blank 16 comprising of four portions may be coupled with four welds, which is a significant improvement over conventional four member back frame that could have more than twenty welds. The tailored welded blank 16 also has an improved nesting, which reduces scrap and cost.

FIG. 4B shows an exemplary one-piece seat back structure 32 that may be cold formed from the tailored welded blank 16 of FIG. 4A, to be mass and cost optimized. This same one-piece structure can also be formed from a monolithic blank. The cold-forming produces a one-piece seat back structure 32 that has varying cross-sections, as shown in FIG. 4C, and has a complex geometry, which allows for coupling of other assemblies (e.g., head rest assembly 22, recliner assembly 24, stowable drive link, etc.) as required. One-piece structures 5 may form complex geometry efficiently, for example, the plurality of required holes may be formed (e.g., cut, pierced) by one station, where conventional structures would require multiple stations in a progressive die to form them all. Additionally, one-piece structures 5 may be formed in one die (e.g., transfer die, etc.), where conventional structures would require multiple progressive dies, each comprising multiple stations to form the individual components, therefore reducing tooling costs. The reduction of mass by utilizing tailored welded blanks 16 may translate into a reduction of packaging space required by the one-piece cold formed seat structure 5. This reduction of packaging space allows for the seat assembly 12 to have an increased volume of low mass foam to improve comfort for the occupant, or to add feature(s) to increase the functionality or utility. The one-piece seat structure 5 produces a reduced mass and reduced cost seat assembly 12 with equal strength to a conventional seat assembly, which allows for an increase in comfort with little impact to the reduction of mass and cost, or allows for the inclusion of additional functionality to offset the reduction of mass and cost. The one-piece cold formed seat structure 5 also provides for a reduction in handling downstream, which further reduces cost in the form of eliminated labor for part handling and eliminated tooling. The one-piece seat structure 5 may also reduce the number of required fasteners downstream, by integrating separate components required by conventional methods.

According to other embodiments, the number, position, and configuration of respective portions 42, as well as the properties (e.g., mechanical, thickness) of the respective portions 42, may be varied to, for example, satisfy specific design requirements (e.g., cost, mass, strength). FIGS. 4A thru 5 are merely illustrative of the flexibility of the one-piece structure 5 made from tailored welded blanks 16. This flexibility results in a seat structure component 5′ which is mass, strength and cost optimized. This flexibility, with respect to material, allows the use of draw quality steels or transformation induced plasticity (TRIP) or Twinning induced plasticity (TWIP) steels in the locations where there are high forming stresses, and allows the use of high strength steels (HSS) in the locations where there are high strength requirements.

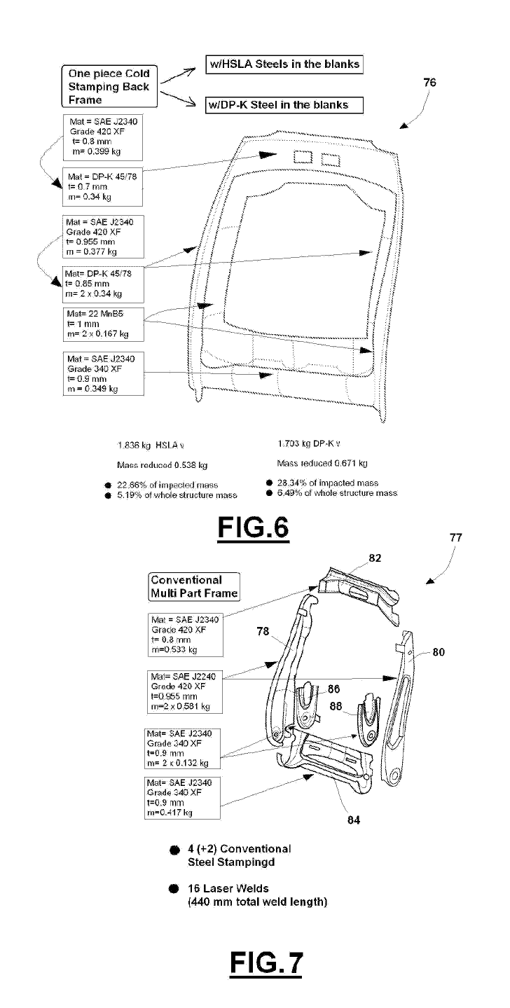

FIG. 6 shows an exemplary embodiment of one-piece seat back structure 32 cold formed from the tailored welded blank 16 of FIG. 4a. The cold forming of the tailored welded blank 16 allows for the one-piece seat back structure 32 to have varying cross-sections and complex geometry, with specific regions having unique materials designed to meet strength and formability requirements. The cold forming process is flexible and is not constrained by the materials specified, as they are merely illustrating the integration of what was conventionally multiple components into one complex component that can be optimized for mass and strength.

Referring now to FIGS. 6 and 7, some comparative advantages of an embodiment of a seat back frame 76 according to the present invention (FIG. 6) and a conventional seat back frame 77 (FIG. 7) can be recognized. The conventional seat back frame 77 (FIG. 7) can be constructed by coupling through conventional means (e.g., welding, etc.) multiple individually stamped parts, including two side members 78, 80, an upper cross member 82, a lower cross member 84, and two support members 86, 88. This conventional process often required the use of support components (S1 and S2) 86, 88 to be included in the construction of the seat back frame 77 to meet the required strength. The alternative is to over-design the side members 78, 80 to accommodate the need to have an increase in strength only in the lower portion of each side member 90, 92. Either conventional method resulted in additional mass and cost (in the form of both piece cost and labor cost). The conventional method of constructing a seat structure involved significant amounts of non-value added time for material handling and secondary operations. In contrast, the exemplary embodiment of the one-piece seat back structure 76 (FIG. 6) offers a mass reduction of 22.7% while offering equal strength as the conventional multiple piece seat back structure of FIG. 7. This reduction is possible by using what are considered by the industry to be conventional (lower cost) materials such as HSLA steels. The flexibility of the one-piece seat structure 10 allows for the use, independently or in combination, of less conventional materials (e.g., high strength steels, ultra high strength steels, aluminum, magnesium, etc.), which have a higher cost, but present the opportunity to gain additional mass savings and also allows for use of those materials in combination with steel (in which case appropriate joining methods, e.g., brazing, cold metal transfer, steer welding, etc, may be considered). The illustrated alternative embodiment of FIG. 6 offers a mass reduction of 28.3% while offering equal strength as the conventional multiple piece seat back structure. One-piece seat structures 5 are not limited by the use of the materials specified, by the number of portions, or by the geometry illustrated. Therefore the mass reduction of another embodiment is not limited to the numbers specified.

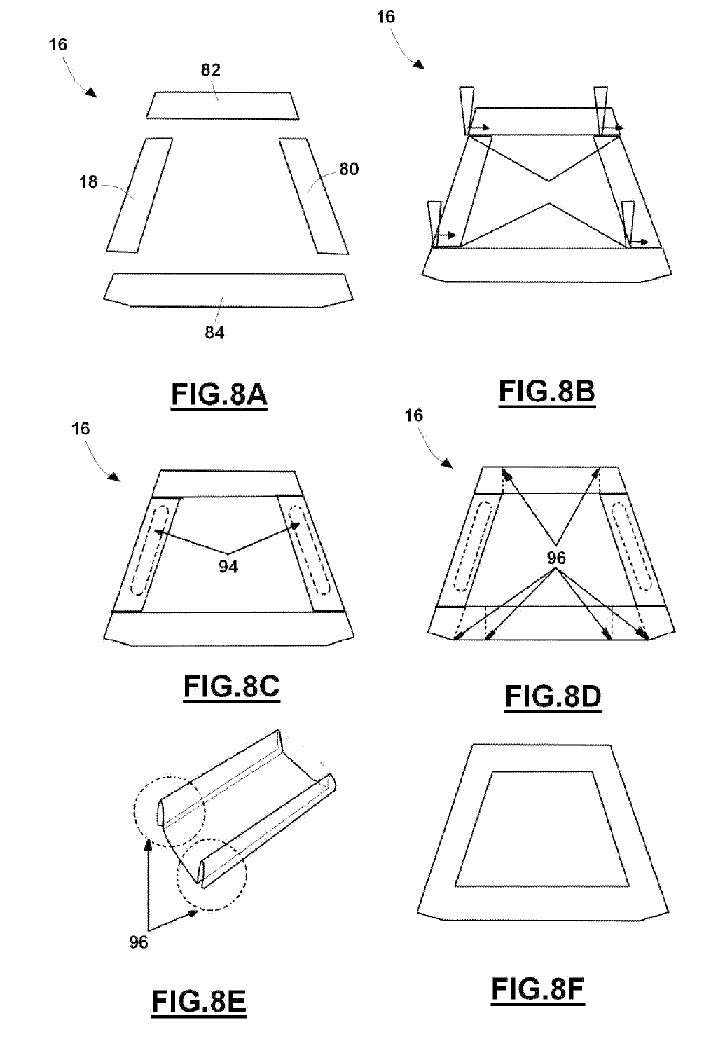

FIGS. 8A thru 8E show an exemplary embodiment of a tailored welded blank 16 and its use in constructing a one-piece seat back structure 32. According to this exemplary embodiment, the tailored welded blank 16 may be constructed of four portions comprising an upper member 82, a lower member 84, and two side members 78, 80, as shown in FIG. 5A. The two side members 78, 80 may come from the same coil of steel, differing from both the upper and lower member 82, 84, which each come from a unique coil of steel. For example, the upper member 82 may be made of a first material and first thickness, the first and second side members 78, 80 may be made from a second material and second thickness, and the lower member 84 may be made from a third material and third thickness. The portions may be coupled to each other via a joining process (e.g., laser welding, etc.) to form an exemplary tailored welded blank 16, as shown in FIG. 8B. An exemplary tailored welded blank 16 may have an initial form or pre-form 94, depending on the complexity of the end geometry, which is shown in FIG. 8C. The exemplary tailored welded blank 16 may then be cold formed, whereby the blank 16 undergoes bending about predetermined bending lines 96 (shown in FIG. 8D), to achieve the required strength by increasing the sectional properties (e.g., moment of inertia, etc.) of the one-piece structure 32 by having the member formed back over itself, wherein there are two material thicknesses in the localized area, as shown in FIG. 8E. Another exemplary embodiment may have increased section properties by having the member formed back over itself more than once, wherein there are three or more material thicknesses in the localized area. The flexibility of the cold forming process allows for localized increased strength to efficiently manage the loads the one-piece structure will be subjected to in vehicle. This flexibility is useful in areas of high loading, for example, where recliner mechanisms 24 are coupled to a seat back structure 18. According to another embodiment, a blank can be made from a monolithic or the same material throughout, as shown in FIG. 8F. FIG. 8F shows a blank in one state of the forming process wherein the center of the blank is already removed to enable construction of the needed shape of the seat back frame.

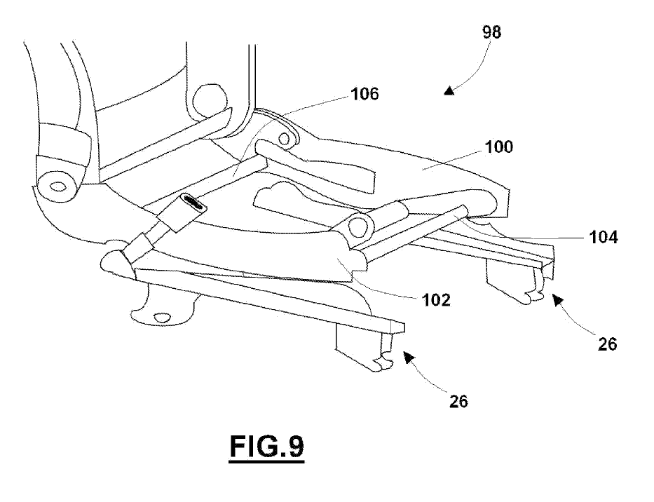

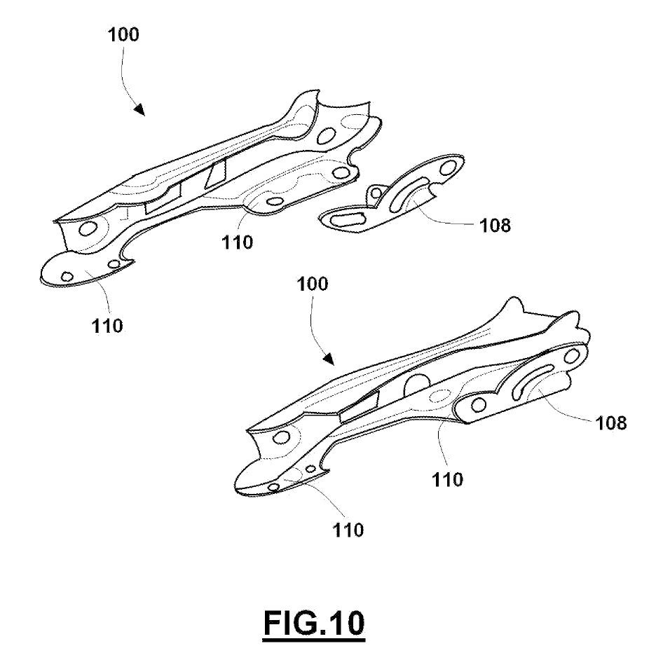

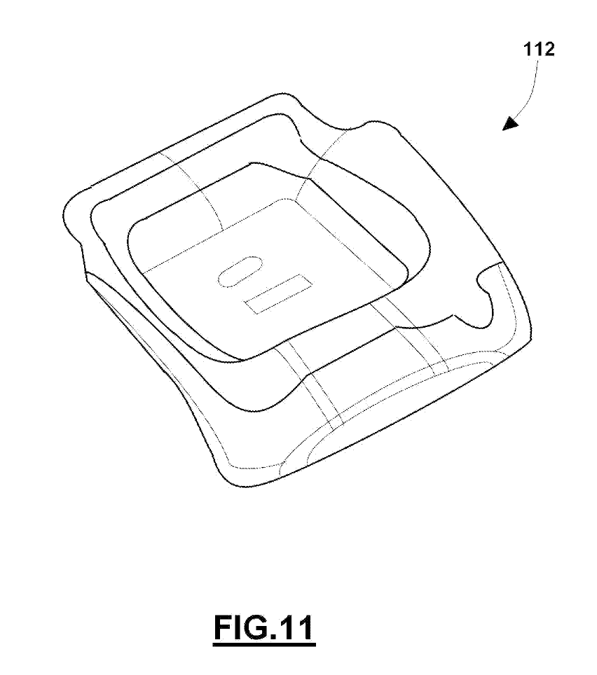

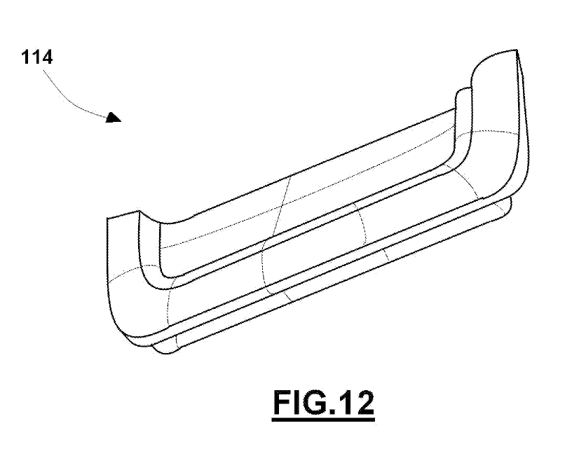

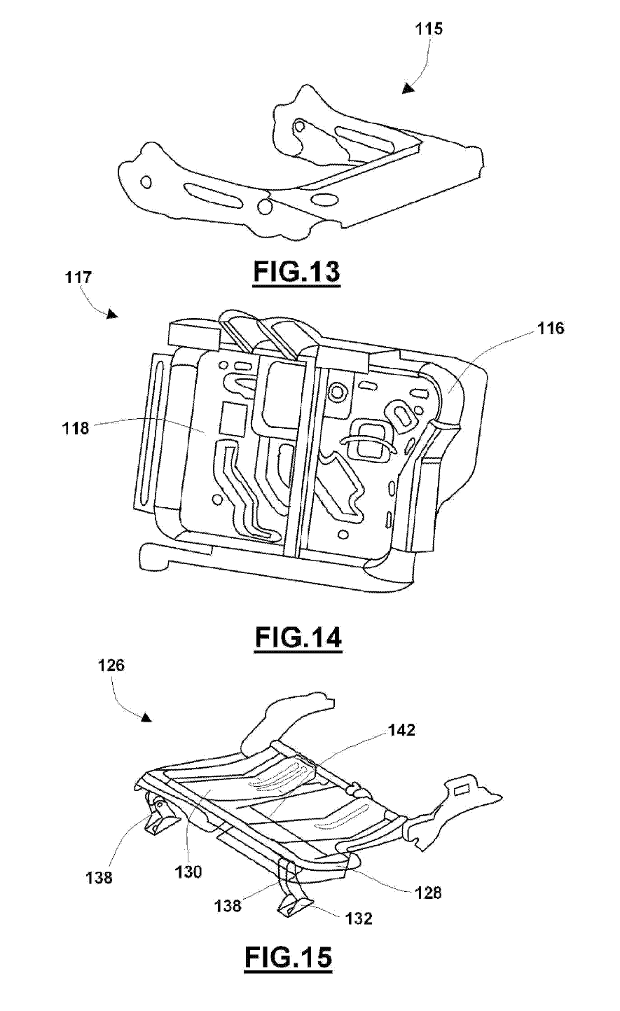

Referring to FIGS. 9 thru 13, exemplary embodiments of other one-piece seat structures 5 and other embodiments of conventional seat structures, which represent opportunities to integrate into one-piece seat structures 5, are shown. FIG. 9 illustrates an exemplary embodiment of a first row seat base structure 98 which includes two base “B-brackets,” 100, 102 two cross tubes 104, 106, at least one reinforcement bracket 108 (FIG. 10), and a plurality of members 110 to couple the base B-brackets 100, 102 to the track assemblies 26 and to the cross tubes 104, 106. An exemplary one-piece seat structure 5 may be cold formed by integrating any combination of these components. FIG. 11 illustrates an exemplary embodiment of a cushion pan 112 (e.g., first row seat base with full cushion pan) which is coupled above the B-brackets 100, 102 to the first row seat base structure 98 of FIG. 9 and supports the foam of the seat cushion assembly 20. The cushion pan 112 may be integrated with the side (or “B”) brackets 100, 102 to form a one-piece seat structure 10 which is mass and cost optimized. FIG. 12 illustrates a half cushion pan 114 (e.g., first row seat base half cushion pan) typically used to increase the structural rigidity of a seat cushion 20, which may be integrated with other seat cushion components, for example the B-brackets 100, 102 and reinforcement members of FIG. 10, to form an exemplary one-piece riser structure 115 as shown in FIG. 13.

Referring to FIG. 14, another exemplary embodiment of a conventional seat back structure 117 to support multiple occupants is illustrated, and includes at least one formed tube 116, at least one back panel 118, a plurality of brackets 120 to attach a belt retractor assembly 122, a ultra high strength tower 124 to transfer the loads from the retractor 122, a plurality of mounting brackets 120 to connect to recliner mechanisms 24, and a plurality of brackets 120 to attach head-rest assemblies 22 to. This embodiment provides significant opportunity to reduce mass and cost, by integrating components into a one-piece seat back structure 32 or multiple one-piece seat structures 5 to be coupled by a secondary operation.

Referring to FIG. 15, another exemplary embodiment of a conventional pivotable seat cushion structure 126 to support multiple occupants is illustrated, and includes at least one formed tube 128, at least one cushion pan 130, a plurality of brackets 132 to attach to the floor of the vehicle 14, a means to pivot 134 the rear of the cushion structure 136, at least one front leg bracket 138 to pivot the front of the cushion 140 with respect to the floor mounting brackets 132, and a plurality of wire 142 to support the foam 34 and to attach trim 36. This embodiment provides significant opportunity to reduce mass and cost, by integrating components into a one-piece seat cushion structure 38 or multiple one-piece seat structures 5 to be coupled by a secondary operation. Those skilled in the art will recognize the broad application of the ability to optimize seat structures by cold-forming one-piece structures 5 that include tailored welded blanks 16.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the one-piece seat structure as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A one-piece seat structure for use in a vehicle seat assembly, the one-piece seat structure comprising:
a tailor welded blank having a first portion having a first set of characteristics and a second portion having a second set of characteristics, and the material characteristics of the first portion differs from the material characteristics of the second portion, wherein the one-piece seat structure is formed from the tailor welded blank using a cold-forming process.

2. The one-piece seat structure of claim 1, wherein the characteristics of the first set of characteristics for the first portion include at least one of shape, size, mass, strength, material type, thickness, function, utility and position.

3. The one-piece seat structure of claim 1, wherein the blank is a tailored welded blank and a monolithic blank.

4. The one-piece seat structure of claim 1, wherein the tailor welded blank is constructed from a tailored welded coil of the first portion coupled to the second portion.

5. The one-piece seat structure of claim 1, wherein the blank is constructed from heat treatable material that has undergone post cold-forming heat treatment processes to further modify characteristics of the first and second portions.

6. The one-piece seat structure of claim 1, wherein the one-piece seat structure is one of a seat back, a seat back frame, a seat back side member, a seat back cross member, a seat base, a seat base frame, a seat base side member, a seat base cross member, and a seat pan.

7. The one-piece seat structure of claim 1, wherein the one-piece seat structure comprises a plurality of portions each having a different set of characteristics.

8. A vehicle seat assembly, comprising:
a seat base and a seat back rotatably coupled to the seat base;
wherein at least one of the seat base and seat back is a one-piece structure having:
a first portion having a set of characteristics and a second portion having a set of characteristics, wherein the characteristics of the first portion differs from the characteristics of the second portion, and the one-piece seat structure is formed from a tailor welded blank using a cold-forming process, the tailor welded blank constructed from the first portion coupled to the second portion.

9. The vehicle seat assembly of claim 8, wherein the characteristics are at least one of shape, size, mass, strength, quantity, material, thickness, function, utility and position.

10. The vehicle seat assembly of claim 8, wherein the tailor welded blank is constructed by coupling the first portion to the second portion.

11. The vehicle seat assembly of claim 10, wherein the tailor welded blank is constructed from a tailored welded coil of the first portion coupled to the second portion.

12. (canceled)

13. A method of forming a one-piece seat structure, the method comprising the steps of:
constructing a tailor welded blank by coupling a first portion having a first set of characteristics to a second portion having a second set of characteristics, wherein the first set of characteristics differs from the second set of characteristics; and
forming the one-piece seat structure from the tailor welded blank using a cold-forming process.

14. The method of claim 13, wherein the characteristics are at least one of shape, size, mass, strength, quantity, material, thickness, function, utility and position.

15. The method of claim 14, wherein the step of constructing further includes constructing the tailor welded blank from a tailored welded coil of the first portion coupled to the second portion.
